(19) United States
(12) Patent Application Publication
(10) Pub. No.: US 2026/0120381 A1
(43) Pub. Date: Apr. 30, 2026

(54) TEXT-TO-IMAGE CUSTOMIZATION WITH CAMERA VIEWPOINT CONTROL

(71) Applicant: Adobe Inc., San Jose, CA (US)

(72) Inventors: Richard Zhang, Burlingame, CA (US); Taesung Park, Sunnyvale, CA (US); Nupur Kumari, Pittsburgh, PA (US); Elya Shechtman, Seattle, WA (US)

(21) Appl. No.: 18/933,622

(22) Filed: Oct. 31, 2024

(51) Int. Cl. G06T 15/00; G06V 10/44

(52) U.S. Cl. CPC G06T 15/00; G06V 10/44

(57) ABSTRACT

In some embodiments, a computing system accesses multiple training images of an object for customizing a text-to-image generative model, comprising one or more transformer models and a three-dimensional (3D) feature prediction model. The computing system extracts a training target feature representation based on a training target image using a transformer model. The computing system predicts a training 3D feature representation in a training target camera viewpoint based on a set of training reference images using the 3D feature prediction model. The computing system reconstructs the training target image of the object based on the training 3D feature representation and the training target feature representation. The computing system adjusts one or more parameters of the 3D feature prediction model by optimizing a loss function based on the training target image and the reconstructed training target image to obtain a trained 3D feature prediction model, thereby customizing the text-to-image generative model.

### FIELD OF THE INVENTION

This disclosure relates generally to generative artificial intelligence. More specifically, but not by way of limitation, this disclosure relates to text-to-image customization with camera viewpoint control.

### BACKGROUND OF THE INVENTION

Text-to-image models enables users to obtain an image that matches a natural language description. A text-to-image model can be customized with user provided images to generate personalized images. A customized text-to-image model allows users to quickly visualize personal objects and favorite places in new environments or with new attributes. For example, a user can customize a text-to-image model with some images of the user's own Teddy bear. The user can prompt the customized text-to-image model with “Teddy bear on a bench in the park.” The customized text-to-image model then produces an image depicting the user's own Teddy bear on a bench in the park.

### BRIEF SUMMARY OF THE INVENTION

Certain embodiments involve text-to-image customization with camera viewpoint control. In one example, a computing system provides multiple training images of an object for customizing a text-to-image generative model. The multiple training images include a training target image with a target camera viewpoint and a set of training reference images with a set of reference camera viewpoints. The text-to-image generative model includes one or more transformer models and a three-dimensional (3D) feature prediction model. The computing system extracts a training target feature representation from the training target image using a transformer model. The computing system predicts a training 3D feature representation in the training target camera viewpoint based on the set of training reference images using the 3D feature prediction model. The computing system reconstructs the training target image of the object based on the 3D feature representation and the training target feature representation to obtain a reconstructed target image. The computing system adjusts one or more parameters of the 3D feature prediction model by optimizing a loss function based on the training target image and the reconstructed target image to obtain a trained 3D feature prediction model, thereby customizing the text-to-image generative model.

### BRIEF DESCRIPTION OF THE DRAWINGS

Features, embodiments, and advantages of the present disclosure are better understood when the following Detailed Description is read with reference to the accompanying drawings.

FIG. 1 depicts an example of a computing environment in which a customized text-to-image generation application provides a customized image based on an input prompt and a target camera viewpoint, according to certain embodiments of the present disclosure.

FIG. 2 depicts an example of a process for customizing a text-to-image generative model with 3D camera viewpoint control, according to certain embodiments of the present disclosure.

FIG. 3 depicts an example of a process for generating an image using a text-to-image generative model customized in FIG. 2, according to certain embodiments of the present disclosure.

FIG. 4 depicts an example of a diagram for customizing a text-to-image diffusion model with camera viewpoint control, according to certain embodiments of the present disclosure.

FIG. 5 depicts an example of a diagram for predicting and rendering a volumetric feature representation conditioned on a target camera viewpoint, according to certain embodiments of the present disclosure.

FIG. 6 depicts an example of a comparison of text-to-image quality in a given target viewpoint between the present method described herein and other methods, according to certain embodiments of the present disclosure.

FIG. 7 depicts example images generated with different text prompts and target viewpoints as conditions using the present method, according to certain embodiments of the present disclosure.

FIG. 8 depicts an example of the computing system for implementing certain embodiments of the present disclosure.

### DETAILED DESCRIPTION OF THE INVENTION

Certain embodiments involve text-to-image customization with camera viewpoint control. For instance, a computing system provides multiple images of an object in multiple camera viewpoints for customizing a text-to-image generative model. The multiple images include a training target image with a target camera viewpoint (e.g., camera pose) and a set of training reference images with a set of reference camera viewpoints. The text-to-image generative model includes a viewpoint-conditioned transformer block comprising one or more transformer models and a feature prediction model. The computing system creates a noised training target image by adding noise data to the training target image, and extracts a training target feature representation from the noised training target image using a transformer model. The computing system predicts a training 3D feature representation in the target camera viewpoint based on the set of training reference images with the set of training reference camera viewpoints using the feature prediction model. The computing system reconstructs the target image of the object based on the training target feature representation and the training 3D feature representation to obtain a reconstructed target image. The computing system adjusts one or more parameters of the feature prediction model by optimizing a loss function based on the target image and the reconstructed target image to obtain a trained 3D feature prediction model, thereby customizing the text-to-image generative model.

Existing customization methods lack accurate camera viewpoint control with respect to an object, because existing text-to-image generative models (e.g., diffusion models) are trained purely on 2D images without ground truth camera viewpoints. As a result, a user often resorts to prompt engineering, for example adding “top-view” in the input prompt, to achieve coarse viewpoint control. However, it is tedious, and the diffusion models often do not follow the added text description regarding view angles.

The present customization process enables precise control of camera viewpoints with respect to the new custom object in a 2D text-to-image generative model. During customization, a feature prediction model is added to a 2D text-to-image generative model (e.g., diffusion model). The feature prediction model learns or is trained to predict neural feature fields in intermediate feature spaces of the diffusion model. The predicted feature fields are rendered and fused with the noisy features in the target camera viewpoint. During training of the feature prediction model, the parameters of the pre-trained diffusion model remain unchanged. During inference, the customized text-to-image generative model offers the flexibility of conditioning the generation process on both a text prompt and a target camera viewpoint.

Certain embodiments of the present disclosure overcome the disadvantages of the prior art. The customization process in the present disclosure provides a customized 2D text-to-image generative model with camera viewpoint control. The customized 2D text-to-image generative model produces images in high alignment with the target object and the target camera viewpoint, while adhering to the user-provided text prompt.

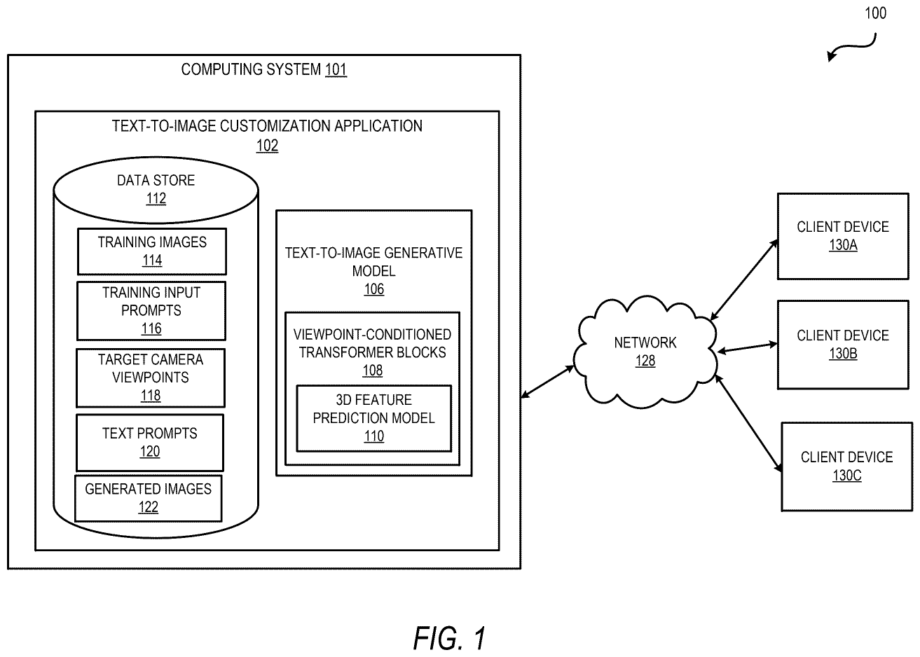

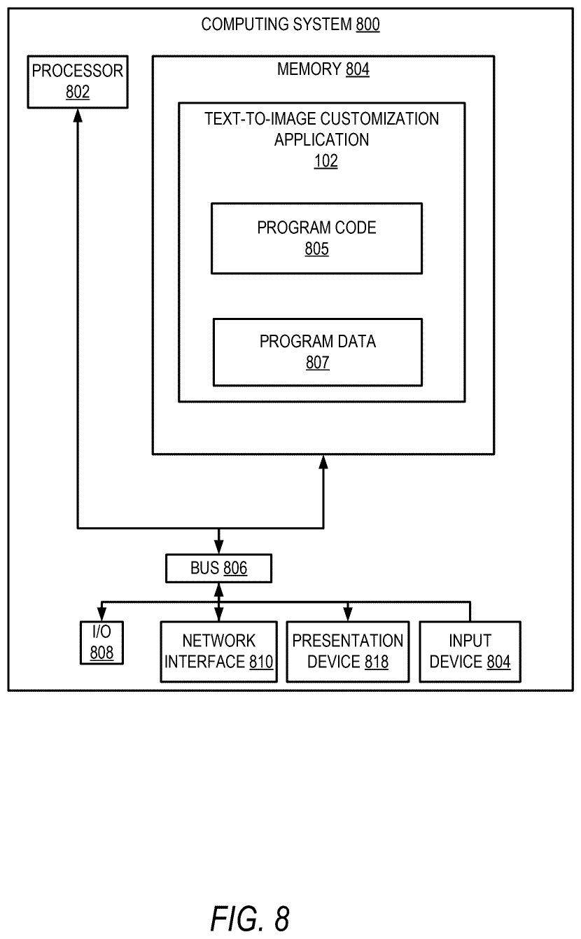

Referring now to the drawings, FIG. 1 depicts an example of a computing environment 100 in which a text-to-image customization application 102 provides a generated image 122 of a custom object in a target camera viewpoint, according to certain embodiments of the present disclosure. In various embodiments, the computing environment 100 includes a computing system 101 in communication with client devices 130A, 130B, and 130C (which may be referred to herein individually as a client device 130 or collectively as the client devices 130) via a network 128. The network 128 may be a local-area network (“LAN”), a wide-area network (“WAN”), the Internet, or any other networking topology known in the art that connects the client device 130 to the text-to-image customization application 102. The computing system 101 can be a server or any other suitable computing device. In some examples, the computing system 101 is the computing system 800 as will be described in FIG. 8. The computing system 101 includes a text-to-image customization application 102. The client device 130 may be a desktop computer, a laptop computer, a mobile computing device or any other suitable computing device.

The client device 130 is configured to transmit multiple training images 114 to the text-to-image customization application 102 for customizing a text-to-image generative model 106.

The multiple training images 114 can include images depicting an object associated with a user from different camera viewpoints (e.g., camera poses). During inference, the client device 130 is configured to provide a text prompt 120 and a target camera viewpoint 118 to the text-to-image customization application 102 for obtaining a generated image 122.

The text-to-image customization application 102 includes a text-to-image generative model 106. The text-to-image generative model 106 is based on a pre-trained text-to-image diffusion model and includes a viewpoint-conditioned transformer block 108, which includes a 3D feature prediction module 110 and one or more pre-trained transformer modules (not shown), which are part of the pre-trained text-to-image diffusion model. The customized text-to-image generative model 106 is configured to generate target images depicting a user-customized object based on an input prompt and a target camera viewpoint. In some examples, the text-to-image generative model 106 is a U-Net consisting of encoder blocks and decoder blocks. Each encoder or decoder block includes a ResNet and one or more transformer layers. Each transformer layer includes one or more transformer models. A transformer model includes a self-attention layer, a cross-attention layer with text condition, and a feed-forward MLP. One or more transformer layers can further include a 3D feature prediction model 110 for incorporating viewpoint conditioning, and become one or more viewpoint-conditioned transformer blocks 108.

During customization, the text-to-image customization application 102 accesses a set of training images 114 to train the text-to-image generative model 106 in batches for customization. The set of training images correspond to different camera viewpoints. In some examples, a batch of four training images are provided to the text-to-image generative model 106. The one training image of the batch is selected as a training target image and the other training images are used as training reference images for training the 3D feature prediction model 110. The text-to-image generative model 106 creates a noisy training target image by adding noise data to the training target image and extracts a target feature representation from the noisy training target image. Meanwhile, the text-to-image generative model 106 extracts the intermediate features from the training reference images corresponding to different camera viewpoints using a set of transformer models. The 3D feature prediction model 110 aggregates the intermediate features in different camera viewpoints from the target viewpoint. For example, from the target viewpoint, the 3D feature prediction model 110 samples and aggregates intermediate features at each point on a target ray to predict 3D volumetric features for the point in the target viewpoint. The 3D feature prediction model 110 then predicts the density and color values using an MLP algorithm. In some examples, the 3D feature prediction model 110 modifies the volumetric features with cross attention and text condition to obtain updated volumetric features. The 3D feature prediction model 110 renders the updated volumetric features to obtain rendered 3D feature representation. The rendered 3D feature representation is concatenated with the target feature representation extracted from the noised training target image to form a combined feature representation.

The text-to-image generative model 106 then uses one or more decoders to denoise the combined feature representation to reconstruct the training target image by predicting the noise added to the target image. During customization, the text-to-image customization application 102 learns parameters of the 3D feature prediction model 110 by minimizing a sum of training losses. Thus, the text-to-image generative model 106 is customized with user provided images of a custom object by training the 3D feature prediction model 110.

During inference, a user provides a text prompt 120 and a target camera viewpoint 118. The trained 3D feature prediction model 110 provides a rendered 3D feature representation of a custom object in the target camera viewpoint based on training images provided during customization. The text-to-image generative model 106 adds noise to the rendered 3D features of a target object, and then denoises the noised rendered 3D feature representation to obtain a generated image 122 of the object in the target camera viewpoint.

The data store 112 is configured to store data processed or generated by the text-to-image customization application 102. Examples of the data stored in data store 112 include training images 114, training input prompts 116, target camera viewpoints 118, text prompts 120, and generated images 122. Intermediate features extracted from the reference images and rendered 3D feature representations in the target camera viewpoints during training can also be stored in the data store 112.

The network architecture shown in FIG. 1 is provided by way of example only. In other embodiments, the text-to-image customization application 102 could also or alternatively be executed locally on a client device 130 or on other device(s) not shown. The text-to-image customization application 102 can, in some embodiments, be a component of a larger software program, for example a graphics editing application.

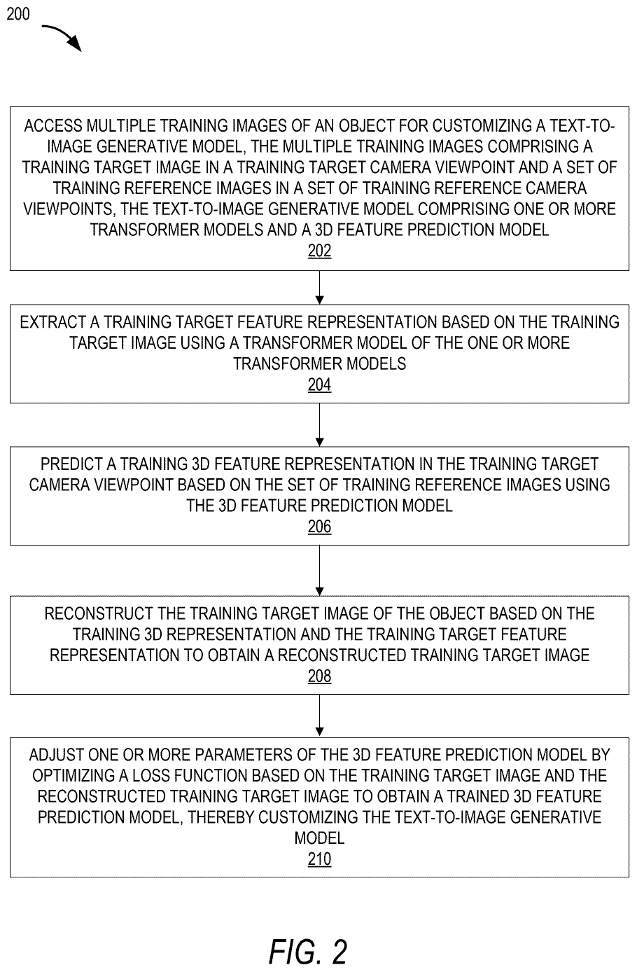

FIG. 2 depicts an example of a process 200 for customizing a text-to-image generative model with camera viewpoint control, according to certain embodiments of the present disclosure. At block 202, the computing system 101 accesses multiple training images of an object for customizing a text-to-image generative model. The text-to-image generative model includes one or more viewpoint-conditioned transformer models, which in turn includes a feature prediction model and one or more transformer models. In some examples, the text-to-image generative model is based on a pre-trained diffusion model consisting of standard transformer blocks as encoders and decoders. One or more of the standard transformer blocks are modified to include one or more viewpoint-conditioned transformer blocks. A viewpoint-conditioned transformer blocks includes a feature prediction model and one or more transformer models.

In some examples, a user provides multiple training images of an object for training the feature prediction model or customizing the text-to-image generative model. In some examples, the user provides a training dataset, including the multiple training images, corresponding camera viewpoints, and corresponding text prompts describing the respective training images. In some examples, the text prompts corresponding to the multiple training images are pre-generated using a generative model. The text-to-image customization application 102 on the computing system 101 trains the 3D feature prediction model 110 with multiple iterations (e.g., 1600). At each training step, the text-to-image customization application 102 samples a subset (e.g., 5) of the multiple images equidistant from each other. In some examples, the text-to-image customization application 102 uses the first image as the training target image with the training target camera viewpoint and the other (e.g., 4) images as training reference images. In some examples, the text-to-image customization application 102 randomly selects one image from the subset of the multiple images as the training target image and uses the rest in the subset as the training reference images. In some examples, the text-to-image customization application 102 uses a generative model (e.g., generative pre-trained transformer (GPT) model) to generate a target text prompt describing the training target image.

At block 204, the computing system 101 extracts a training target feature representation based on the training target image using a transformer model of the one or more transformer models. The text-to-image generative model 106 of the text-to-image customization application 102 creates a noised training target image by adding noise data to the target image. For example, the text-to-image customization application 102 of the computing system 101 sequentially adds to the training target image Gaussian perturbations in T timesteps during a forward Markov process to transform the training target image to a random noise x_{T}˜N(0, I).

The first transformer model is a pre-trained component in the viewpoint-conditioned transformer block 108. In some examples, a residual neural network (ResNet) layer processes the noised training target image to extract an intermediate feature representation and transmits the intermediate feature representation to the first transformer model for feature extraction. In some examples, a target prompt is generated based on the training target image using a GPT model or other suitable generative model, and provided to the first transformer model as a condition. The first transformer model extracts the target feature representation Wₓ based on the noised training target image and the target prompt.

At block 206, the computing system 101 predicts a training 3D feature representation in the training target camera viewpoint based on the set of training reference images using the feature prediction model. Similar to block 204, the text-to-image generative model 106 of the text-to-image customization application 102 extracts a set of 2D feature representations from the set of training reference models using a set of transformer models. The set of transformer models are pre-trained transformer models in the viewpoint-conditional transformer block 108. The set of transformer models extract a set of 2D feature representations from the set of reference images and the target prompt corresponding to the training target image. The 3D feature prediction model 110 samples and aggregates the set of 2D feature representations to predict volumetric features in the training target camera viewpoint. For example, the 3D feature prediction model 110 predicts volumetric features from the set of feature representations using Equations (1) and (2) as shown below.

$${V}_{i} = MLP ( Sample ( {W}_{i} ; {π}_{i}^{p} ) , γ ( d ) , γ ( p ) ) , i = 1 , … , N \qquad ( 1 )$$

$$\overline{V} = ψ ( {V}_{1} , … , {V}_{N} ) \qquad ( 2 )$$

In equation (1), πᵢ denotes a reference camera viewpoint, πᵢ^{p} denotes a projected location for a point p on a target ray with direction d on an image plane with a given view πᵢ from a target camera viewpoint Ø, and γ denotes the frequency encoding. In equation (2), ψ is an aggregation function. In some examples, the aggregation function ψ is a weighted average function, where a linear layer predicts the weights based on Vᵢ, πᵢ, and target camera viewpoint Ø. In some examples, the aggregated feature V̅ is updated with the target prompt c, using equation (3).

$$\hat{V} = CrossAttn ( \overline{V} , c ) \qquad ( 3 )$$

The 3D feature prediction model 110 also predicts the density σ and color C of a 3D point using equation (4) as shown below.

$$( σ , C ) = MLP ( \overline{V} ) \qquad ( 4 )$$

In some examples, the 3D feature prediction model is derived from a neural radiance field (NeRF) algorithm. In some examples, the 3D feature prediction model 110 uses or implements a NeRF algorithm to render the 3D feature representation, based on equation (5), where Tⱼ denotes transparency, and δⱼ denotes a delta distance around a point.

$${W}_{y} ( r ) = {\sum }_{j = 1}^{{N}_{f}} {T}_{j} ( 1 - exp ( - {σ}_{j} {δ}_{j} ) ) {\hat{V}}_{j} \qquad ( 5 )$$

At block 208, the computing system 101 reconstructs the training target image of the object based on the training 3D representation and the training target feature representation using the text-to-image generative model to obtain a reconstructed training target image. In some examples, the text-to-image customization application 102 concatenates the rendered 3D representation W_{y} and the target feature representation Wₓ at block 204 to obtain a combined feature representation. In some examples, the viewpoint-conditioned transformer block 108 projects the combined feature representation into an original feature output space using a linear layer for reconstructing the target input image.

At block 210, the computing system 101 adjusts one or more parameters of the 3D feature prediction model by optimizing a loss function based on the training target image and the reconstructed training target image to obtain a trained feature prediction model, thereby customizing a text-to-image generative model. The loss function includes a default diffusion model reconstruction loss related to the transformer models as shown in Equation (6). In Equation (6), M is the object mask, e is the noise added to the target image when training diffusion model, Ee is the predicted noise from the diffusion model, AND xₜ is the target noisy image. In some examples, the reconstruction loss is calculated only in the object masks region.

$${ℒ}_{diffusion} = {\sum }_{r} M {w}_{t} ‖ ϵ - {ϵ}_{θ} ( {x}_{t} , t , c ) ‖ \qquad ( 6 )$$

The loss function also includes a color reconstruction loss related to the feature prediction model, as shown in Equation (7).

$${ℒ}_{rgb} = {\sum }_{r} ‖ M ( r ) ( {C}_{gt} ( r ) - {\sum }_{j = 1}^{{N}_{f}} {T}_{j} ( 1 - exp ( - {σ}_{j} {δ}_{j} ) ) C ) ‖ \qquad ( 7 )$$

The loss function also includes two mask-based losses: a silhouette loss and a background suppression loss. The silhouette loss, calculated by Equation (8), forces the rendered opacity to be similar to the object mask. The background suppression loss, calculated by Equation (9), enforces the density of all background rays to be zero.

$${ℒ}_{s} = {\sum }_{r} ‖ M ( r ) - {\sum }_{j = 1}^{{N}_{f}} {T}_{j} ( 1 - exp ( - {σ}_{j} {δ}_{j} ) ) ‖ \qquad ( 8 )$$

$${ℒ}_{bg} = {\sum }_{r} ( 1 - M ( r ) ) {\sum }_{j = 1}^{{N}_{f}} ‖ ( 1 - exp ( - {σ}_{j} {δ}_{j} ) ) ‖ \qquad ( 9 )$$

Thus, the training loss function is shown in Equation (10).

$$ℒ = {ℒ}_{diffusion} + {λ}_{rgb} {ℒ}_{rgb} + {λ}_{b g} {L}_{b g} + {λ}_{s} {ℒ}_{s} \qquad ( 10 )$$

In equation (10), λ_{rgb}, λ_{bg}, and λₛ are hyperparameters for controlling the rendering quality of intermediate images and the final denoised images. The hyperparameters are fixed in each iteration. And the three feature prediction model related losses are averaged across all viewpoint-conditioned transformer blocks.

In some examples, a token embedding, described as “V*,” is also constructed for the object during customization. The process 200 can iterate multiple times until the one or more parameters of the 3D feature prediction model are optimized. Process 200 describes customization of one viewpoint-conditioned transformer block 108. However, the text-to-image generative model 106 can include multiple viewpoint-conditioned transformer blocks 108, each of which includes a 3D feature prediction model 110. That is, multiple 3D feature prediction models 110 can be trained using the process 300. For examples, a pre-trained text-to-image diffusion model is a U-Net with 70 transformer layers for encoders blocks, middle blocks, and decoder blocks. 12 of the 70 transformer layers can be modified with viewpoint-conditioning, that is, by adding a 3D feature prediction model to become viewpoint-conditioned transformer blocks 108. Among the 12 viewpoint-conditioned transformer blocks 108, 4 are for in the encoders, 3 are in the middle, and 5 are in the decoders.

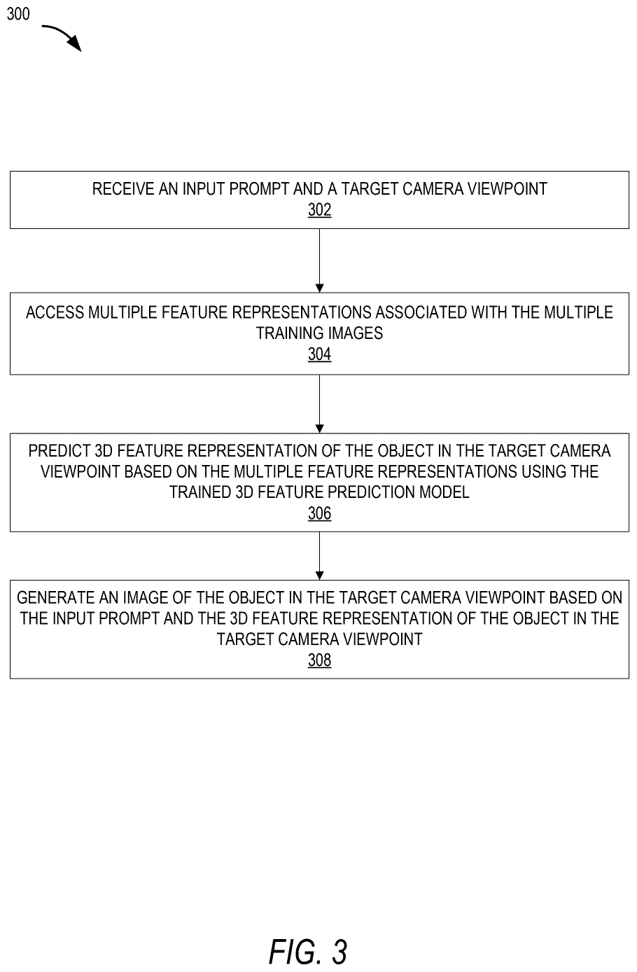

FIG. 3 depicts an example of a process 300 for generating an image using a text-to-image generative model customized in FIG. 2, according to certain embodiments of the present disclosure. At block 302, a computing system 101 receives an input prompt and a target camera viewpoint. A user can type in the input prompt via a GUI of the client device 130. The input prompt describes an image the user intends to obtain. The input prompt can include an object identification and a context of the object. An example input prompt is “a car parked by a snowy mountain range.” The object is a “car,” for which the text-to-image generative model is customized. The user can also select a target camera viewpoint with respect to the object via the GUI of the client device 130. For example, the GUI includes a GUI element depicting a car model, which can be manipulated via a mouse to show the car model in different viewpoint. A user can manipulate the car model to a particular viewpoint to represent the target camera viewpoint for car in the image to be generated.

At block 304, a computing system 101 accesses multiple feature representations associated with the multiple training images. In some examples, the text-to-image generative model 106, which is customized in FIG. 2, extracts the multiple feature representations from the multiple training images using a subset of the one or more transformer models during inference. In some examples, the multiple feature representations associated with the multiple training images are extracted during training and are stored in the data store 112. During the inference as in process 300, the text-to-image generative model 106 accesses the data store 112 to retrieve the multiple feature representations or a subset of the multiple feature representations.

At block 306, a computing system 101 predicts a 3D feature representation of the object in the target camera viewpoint based on the multiple feature representations using the trained 3D feature prediction model 110. Similar to block 206, the text-to-image generative model 106 predicts the 3D feature representation of the object in the target camera viewpoint selected by a user at block 302 based on the multiple feature representations obtained from block 306 using the feature prediction model trained at block 210. In some examples, the 3D feature prediction model 110 predicts the 3D feature representation in a triplane feature space. In some examples, the 3D feature prediction model 110 predicts the 3D feature representation in a pixel feature space. In some examples, the 3D feature prediction model 110 renders the 3D feature representation using a NeRF algorithm to obtain a rendered 3D feature representation for image generation at block 308.

At block 308, a computing system 101 generates an image of the object in the target camera viewpoint based on the input prompt and the 3D feature representation of the object. In some examples, the text-to-image generative model 106 concatenates the 3D feature representation or the rendered 3D feature representation with noise data (e.g., Gaussian noise) to obtain a noised 3D feature representation. The text-to-image generative model 106 then denoises the noised 3D feature representation using a subset of transformer models conditioned on the input prompt to generate an image depicting the object in the target camera viewpoint in the context described by the input prompt. Following the example input prompt at block 302, the text-to-image generative model 106 generates an image depicting a car (e.g., the user's car) from a particular viewpoint with a snowy mountain range in the background.

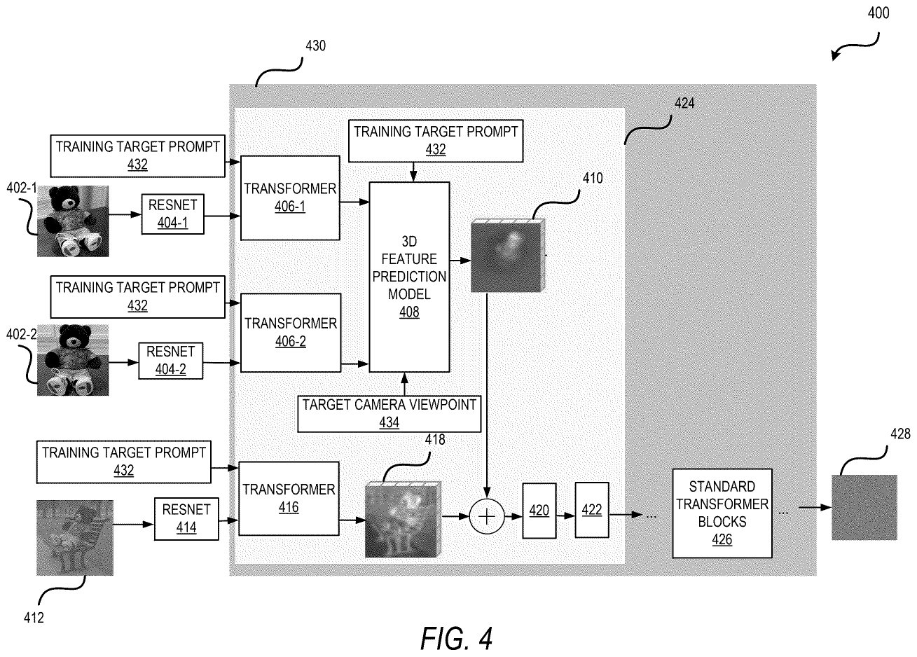

FIG. 4 depicts an example of a diagram 400 for customizing a text-to-image diffusion model with camera viewpoint control, according to certain embodiments of the present disclosure. The text-to-image diffusion model 430, which corresponds to the text-to-image generative model 106 in FIG. 1, includes one or more viewpoint-conditioned transformer blocks 424 and one or more standard transformer blocks 426 for encoding or decoding. A viewpoint-conditioned transformer block 424 includes one or more transformer models (e.g., 406, or 416) and a 3D feature prediction model 408. The 3D feature prediction model 408 corresponds to the 3D feature prediction model 110 in FIG. 1. A standard transformer block 426 includes one or more transformer models.

A training target image is pre-processed with noise to become a noised training target image 412. A residual neural network (ResNet) 414 is used to process the noised training target image 412 to obtain an intermediate target feature map zo. The ResNet 414 is a standard neural network block which facilitates training of the viewpoint-conditioned transformer block using features of the training target image 432 by having residual connections. A transformer model 415 in the viewpoint-conditioned transformer block 424 extracts 2D training target features Wₓ 418.

In parallel to processing the training reference images 402, multiple training reference images 402 are provided to the viewpoint-conditioned transformer block 424. In FIG. 4, two training reference images 402-1 and 402-2 are illustrated in the diagram 400 as an example. The training reference images 402 are provided to a ResNet 404 (e.g., 404-1 and 404-2) prior to the viewpoint-conditioned transformer block 424. Similar to the ResNet 414, the ResNet 404 is a standard neural network block which facilitates training of the viewpoint-conditioned transformer block using features of the training reference images 402 by having residual connections. The ResNet 404 provides an intermediate feature map z; related to the training reference images 402 to a transformer model 406. A training target prompt 432 is also provided to the transformer model 406 as a condition. In some examples, a GPT model is implemented to generate a caption for a training target image, and the generated caption is used as the training target prompt 432. In some examples, a Text-to-Text Transfer Transformer (T5) model is implemented to generate an embedding for the training target prompt 432 and provide to the transformer models 406 as a condition. The transformer models 406 are pre-trained to extract 2D training reference features Wᵢ from the training reference images 402 or the intermediate feature maps zᵢ conditioned on the training target prompt 432.

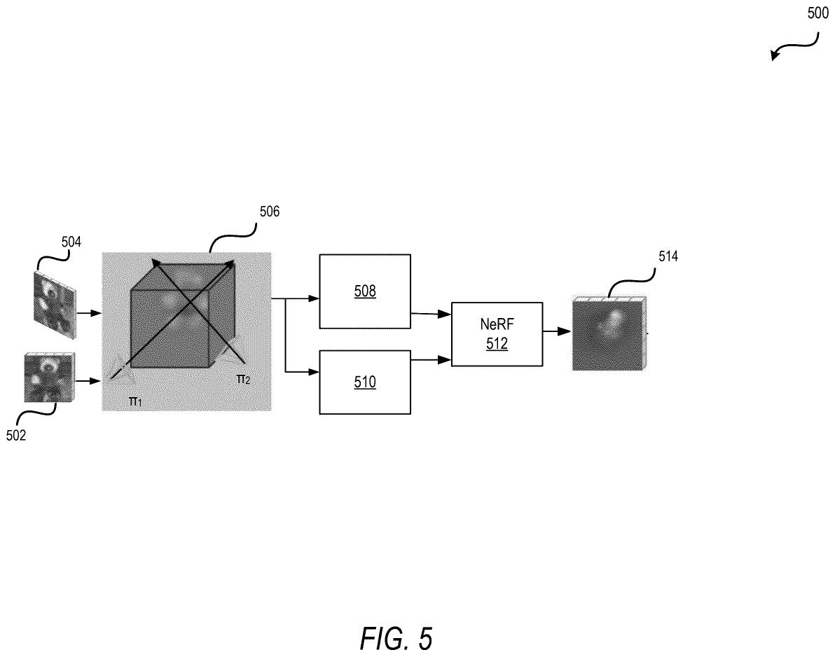

The 2D training reference features Wᵢ are then provided to the 3D feature prediction model 408 conditioned on the training target prompt 432 and the target camera viewpoint 434 corresponding to the noised training target image 412. The 3D feature prediction model 408, which will be described in FIG. 5 in detail, provides a rendered 3D feature representation W_{y} 410.

The rendered 3D feature representation W_{y} 410 and the 2D target features Wₓ 418 are concatenated to become a combined feature representation and projected to the original channel dimension using a linear layer 420. A feedforward MLP 422 is used to further process the combined feature representation. A standard transformer block 426 is used to decode the combined feature representation to predict the noise 428 added to the training target image, thereby reconstructing the training target image. Compared to the viewpoint-conditioned transformer block 424, the standard transformer block 426 includes one or more transformer models (e.g., 406 or 416), but does not include a 3D feature prediction model 408 which is conditioned on a target camera viewpoint.

FIG. 4 illustrates one viewpoint-conditioned transformer block 424 for feature encoding and one standard transformer block 426 for feature decoding. However, the text-to-image diffusion model 430 may include multiple viewpoint-conditioned transformer blocks 424 for encoding and decoding. The training process in FIG. 4 can iterate multiple times to eventually reconstruct the training target image close to the original training target image, during which the parameters of the 3D feature prediction model are adjusted. Each training iteration, the text-to-image diffusion model 430 predicts the noise data ϵ 428 in the noised training target image 412. The noise data ϵ are used to calculate training losses, as shown in Equations (6)-(9), for optimizing parameters in the 3D feature prediction model 408, while the parameters in the transformer models 406 and 416 are frozen.

FIG. 5 depicts an example of a diagram 500 for predicting and rendering a volumetric feature representation conditioned on a target camera viewpoint, according to certain embodiments of the present disclosure. The feature prediction model 408 learns or predicts a 3D feature Vᵢ in a target camera viewpoint in a feature space 506 based on 2D training reference feature Wᵢ extracted from corresponding reference images in corresponding reference camera viewpoints πᵢ. FIG. 5 shows 2D training reference feature W₁ 502 in reference camera viewpoint π₁ and 2D training reference feature W₂ 504 in reference camera viewpoint π₂ corresponding to training reference images 402-1 and 402-2 as an example. However, there can be more 2D training reference features from other training reference images. The feature space 506 can be a triplane feature space or a pixel feature space. The predicted 3D features Vᵢ from the reference images are aggregated into an aggregated volumetric feature V̅. A cross-attention layer 508 processes the aggregated volumetric feature V̅ conditioned on a training target prompt, for example a training target prompt 432 during training, to provide an updated volumetric feature representation \hat{V}. Meanwhile, an MLP algorithm 510 predicts a density and color of a 3D point in the feature space in the target camera viewpoint based on the aggregated volumetric feature V̅. A NeRF algorithm 512 renders the updated volumetric feature representation \hat{V} based on the density predicted by the MLP algorithm 510, for example using Equation (5), to provide a rendered volumetric feature representation 514, which corresponds to the rendered 3D feature representation W_{y} 410 in FIG. 4.

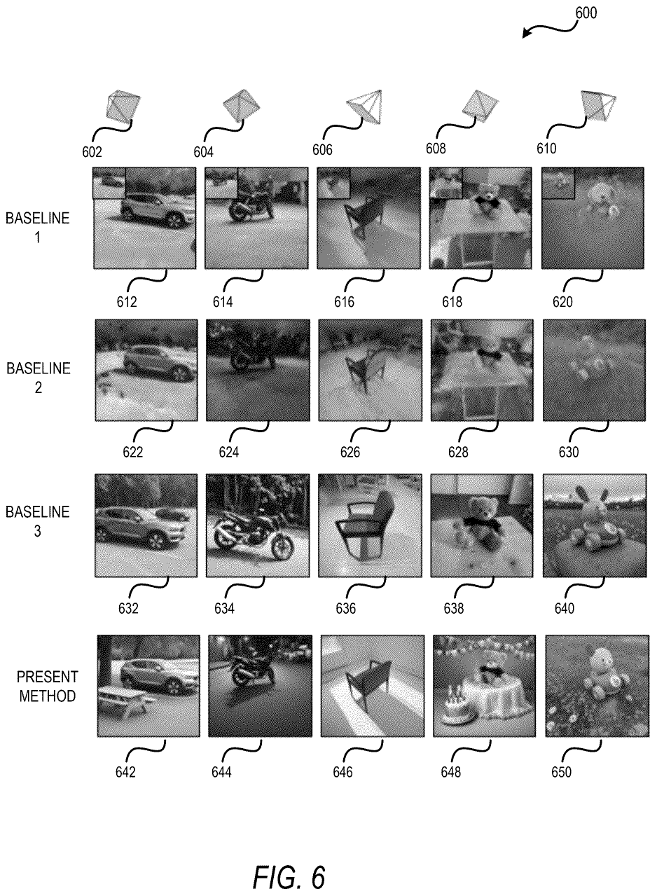

FIG. 6 depicts an example of a comparison of text-to-image quality in a given target viewpoint between the present method described herein and other methods, according to certain embodiments of the present disclosure. Three baseline methods are used to compare with the present method. Baseline method 1 is an image-editing-based method, which edits a NeRF rendered image from an input viewpoint. Baseline method 2 is a 3D editing method that trains a NeRF model for each input prompt. Baseline method 3 is a customization method based on a Low-Rank Adaptation (LoRA) fine-tuned by concatenating camera viewpoint information to text embeddings. The four methods generated images with custom objects, including car, motorcycle, chair, teddy bear, and toy, with corresponding camera viewpoints 602-610 and input prompts. The input prompt for car images (column 1) is “A V* car next to a picnic table in a park.” The input prompt for motorcycle images (column 2) is “A V* motorcycle parked on a city street at night.” The input prompt for chair images (column 3) is “A red V* chair in a white room.” The input prompt for teddy bear images (column 4) is “A V* teddy bear next to a birthday cake with candles.” The input prompt for toy images (column 5) is “a V* toy in a grassy field surrounded with wildflowers.” V* tokens are used in the present method and the baseline method 3.

It can be seen in FIG. 6 that baseline method 1 often fails at generating photorealistic results (e.g., images 612-620). Baseline method 2 maintains 3D consistency but generates blurred images for text prompts that change the background scene (e.g., images 622-630). Baseline method 3 fails to generalize and overfits to the training views (e.g., images 632-640). The present method performs on par or better in keeping the target identity and viewpoints while incorporating the new text prompt and following multiple text conditions, for example image 646 turning the chair red and placing it in a white room. Human preference evaluation as shown in Table I also shows that the present method is preferred over all baseline methods for text alignment, image alignment to target concept, and photorealism, except baseline method 3 which overfits training images.

TABLE 1
Human preference evaluation

| | Text | Image | |
|---|---|---|---|
| Method | Alignment | Alignment | Photorealism |
| Baseline 1 | 32.47 ± 2.39% | 35.86 ± 2.50% | 26.18 ± 2.82% |
| vs. Present | 67.53 ± 2.39% | 64.14 ± 2.50% | 73.82 ± 2.82% |
| Baseline 2 | 27.13 ± 2.83% | 24.36 ± 3.35% | 12.90 ± 2.67% |
| vs. Present | 72.87 ± 2.83% | 75.64 ± 3.35% | 87.10 ± 2.67% |
| Baseline 3 | 32.26 ± 2.67% | 66.97 ± 2.50% | 52.51 ± 2.75% |
| vs. Present | 67.64 ± 2.67% | 33.03 ± 2.50% | 47.49 ± 2.75% |

In addition, Contrastive Language-Image Pretraining (CLIP) scores for text alignment and self-distillation with no labels (DINO)-v2 scores for visual similarity to target concepts are also calculated for images of each target concept generated using the baseline methods and the present method. The present method results in higher CLIP text alignment while maintaining visual similarity to target concepts as indicated by DINO-v2 scores.

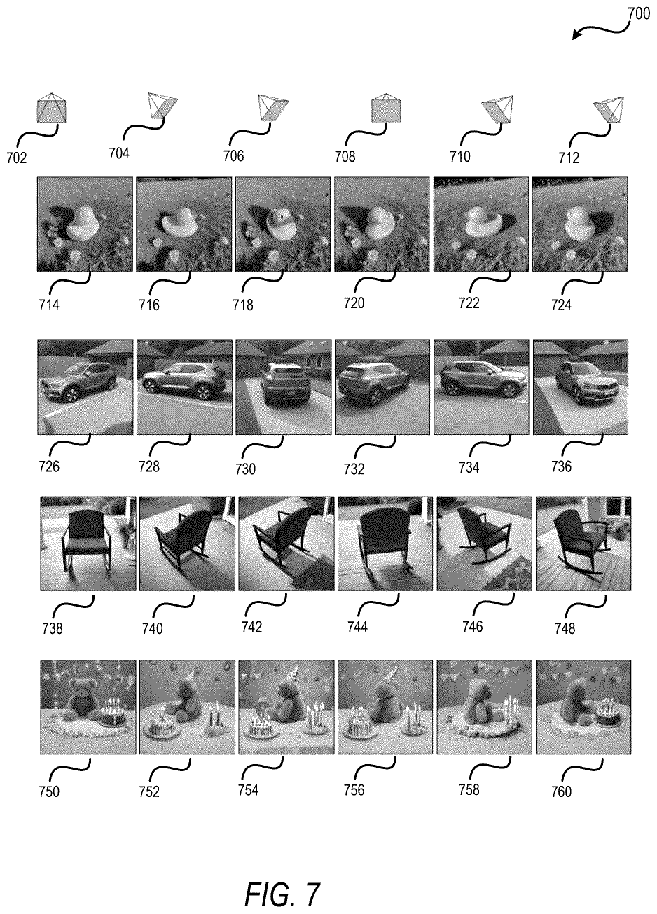

FIG. 7 depicts example images generated with different text prompts and target viewpoints as conditions using the present method, according to certain embodiments of the present disclosure. FIG. 7 demonstrates the present method's effectiveness on four different types of prompts in six different target camera viewpoints (e.g., viewpoints 702-712) for four custom objects (e.g., rubber duck, car, chair, teddy bear). Images 714-724 are generated for a toy using a first text prompt “A V* rubber duck sitting in a grassy field, surrounded by wildflowers.” The first text prompt specifies a different scene compared to the reference images used for object customization. Images 726-726 are generated for a car using a second text prompt “a green V* car in a driveway, next to a house.” The second text prompt specifies a color change compared to reference images used for customization. Images 738-748 are generated for a chair using a third text prompt “a rocking V* chair on a porch.” The third text prompt specifies a shape change compared to reference images used for object customization. Images 750-760 are generated for the teddy bear using a fourth text prompt “a V* teddy bear next to a birthday cake with candles.” The fourth text prompt specifies a new object insertion compared to reference images used for object customization.

It can be seen that the present method learns the identities of the custom objects while allowing the user to control the camera viewpoint and text prompt for generating the object in new contexts, such as changing scene, color, or shape. In each row, the images are generated with the same seeds (e.g., reference images) while changing the camera viewpoints around the object in a turntable manner.

Any suitable computing system or group of computing systems can be used for performing the operations described herein. For example, FIG. 8 depicts an example of the computing system 800 for implementing certain embodiments of the present disclosure. The implementation of computing system 800 could be used to implement the text-to-image customization application 102. In other embodiments, a single computing system 800 having devices similar to those depicted in FIG. 8 (e.g., a processor, a memory, etc.) combines the one or more operations depicted as separate systems in FIG. 1.

The depicted example of a computing system 800 includes a processor 802 communicatively coupled to one or more memory devices 804. The processor 802 executes computer-executable program code stored in a memory device 804, accesses information stored in the memory device 804, or both. Examples of the processor 802 include a microprocessor, an application-specific integrated circuit (“ASIC”), a field-programmable gate array (“FPGA”), or any other suitable processing device. The processor 802 can include any number of processing devices, including a single processing device.

A memory device 804 includes any suitable non-transitory computer-readable medium for storing program code 805, program data 807, or both. A computer-readable medium can include any electronic, optical, magnetic, or other storage device capable of providing a processor with computer-readable instructions or other program code. Non-limiting examples of a computer-readable medium include a magnetic disk, a memory chip, a ROM, a RAM, an ASIC, optical storage, magnetic tape or other magnetic storage, or any other medium from which a processing device can read instructions. The instructions may include processor-specific instructions generated by a compiler or an interpreter from code written in any suitable computer-programming language, including, for example, C, C++, C#, Visual Basic, Java, Python, Perl, JavaScript, and ActionScript.

The computing system 800 executes program code 805 that configures the processor 802 to perform one or more of the operations described herein. Examples of the program code 805 include, in various embodiments, the application executed by the text-to-image customization application 102, or other suitable applications that perform one or more operations described herein. The program code may be resident in the memory device 804 or any suitable computer-readable medium and may be executed by the processor 802 or any other suitable processor.

In some embodiments, one or more memory devices 804 stores program data 807 that includes one or more datasets and models described herein. Examples of these datasets include single-view feature representations (e.g., single-view feature triplanes), multi-view feature representations (e.g., multi-view feature triplanes), 3D representations, etc. In some embodiments, one or more of data sets, models, and functions are stored in the same memory device (e.g., one of the memory devices 804). In additional or alternative embodiments, one or more of the programs, data sets, models, and functions described herein are stored in different memory devices 804 accessible via a data network. One or more buses 806 are also included in the computing system 800. The buses 806 communicatively couples one or more components of a respective one of the computing system 800.

In some embodiments, the computing system 800 also includes a network interface device 810. The network interface device 810 includes any device or group of devices suitable for establishing a wired or wireless data connection to one or more data networks. Non-limiting examples of the network interface device 810 include an Ethernet network adapter, a modem, and/or the like. The computing system 800 is able to communicate with one or more other computing devices (e.g., client device 130) via a data network using the network interface device 810.

The computing system 800 may also include a number of external or internal devices, an input device 820, a presentation device 818, or other input or output devices. For example, the computing system 800 is shown with one or more input/output (“I/O”) interfaces 808. An I/O interface 808 can receive input from input devices or provide output to output devices. An input device 820 can include any device or group of devices suitable for receiving visual, auditory, or other suitable input that controls or affects the operations of the processor 802. Non-limiting examples of the input device 820 include a touchscreen, a mouse, a keyboard, a microphone, a separate mobile computing device, etc. A presentation device 818 can include any device or group of devices suitable for providing visual, auditory, or other suitable sensory output. Non-limiting examples of the presentation device 818 include a touchscreen, a monitor, a speaker, a separate mobile computing device, etc.

Although FIG. 8 depicts the input device 820 and the presentation device 818 as being local to the computing device that executes the text-to-image customization application 102, other implementations are possible. For instance, in some embodiments, one or more of the input device 820 and the presentation device 818 can include a remote client-computing device that communicates with the computing system 800 via the network interface device 810 using one or more data networks described herein.

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multi-purpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alternatives to, variations of, and equivalents to such embodiments. Accordingly, it should be understood that the present disclosure has been presented for purposes of example rather than limitation, and does not preclude the inclusion of such modifications, variations, and/or additions to the present subject matter as would be readily apparent to one of ordinary skill in the art.

What is claimed is:

1. A method performed by one or more processing devices, comprising:
accessing multiple training images of an object for customizing a text-to-image generative model, the multiple training images comprising a training target image corresponding to a training target camera viewpoint and a set of training reference images corresponding to a set of training reference camera viewpoints, the text-to-image generative model comprising one or more transformer models and a three-dimensional (3D) feature prediction model;
extracting a training target feature representation based on the training target image using a transformer model of the one or more transformer models;
predicting a training 3D feature representation in the training target camera viewpoint based on the set of training reference images using the 3D feature prediction model;
reconstructing the training target image of the object based on the training 3D feature representation and the training target feature representation to obtain a reconstructed training target image; and
adjusting one or more parameters of the 3D feature prediction model by optimizing a loss function based on the training target image and the reconstructed training target image to obtain a trained 3D feature prediction model, thereby customizing the text-to-image generative model.

2. The method of claim 1, further comprising:
receiving an input prompt and a target camera viewpoint;
accessing multiple feature representations associated with the multiple training images;
predicting a 3D feature representation of the object in the target camera viewpoint based on the multiple feature representations using the trained 3D feature prediction model; and
generating an image of the object in the target camera viewpoint based on the input prompt and the 3D feature representation of the object in the target camera viewpoint.

3. The method of claim 2, further comprising:
enabling a client device to select the target camera viewpoint via graphical user interface (GUI) element associated with the object.

4. The method of claim 2, further comprising:
rendering the 3D feature representation in the target camera viewpoint using a neural rendering algorithm to obtain a rendered 3D feature representation;
concatenating the rendered 3D feature representation with Gaussian noise to obtain a noised 3D feature representation rendering of the object in the target camera viewpoint; and
generating the image of the object in the target camera viewpoint based on the input prompt and the noised 3D feature representation rendering of the object in the target camera viewpoint.

5. The method of claim 1, further comprising:
creating a noised training target image by adding training noise data to the training target image; and
extracting the training target feature representation from the noised training target image using the transformer model of the one or more transformer models.

6. The method of claim 1, further comprising:
extracting a set of training two-dimensional (2D) feature representations from the set of training reference images using a set of transformer models of the one or more transformer models; and
predicting the training 3D feature representation in the training target camera viewpoint based on the set of training 2D feature representations using the 3D feature prediction model.

7. The method of claim 1, further comprising:
generating a training target prompt based on the training target image using a generative pre-trained transformer (GPT) model; and
providing the training target prompt to the one or more transformer models as a condition.

8. The method of claim 1, further comprising:
rendering the training 3D feature representation using a neural rendering algorithm to obtain a rendered training 3D feature representation; and
concatenating the rendered training 3D feature representation with the training target feature representation to obtain a combined training feature representation.
reconstructing the training target image by decoding the combined training feature representation.

9. A system, comprising:
a memory component;
a processing device coupled to the memory component, the processing device to perform operations comprising:
accessing multiple training images of an object for customizing a text-to-image generative model, the multiple training images comprising a training target image corresponding to a training target camera viewpoint and a set of training reference images corresponding to a set of training reference camera viewpoints, the text-to-image generative model comprising one or more transformer models and a three-dimensional (3D) feature prediction model;
extracting a training target feature representation based on the training target image using a transformer model of the one or more transformer models;
predicting a training 3D feature representation in the training target camera viewpoint based on the set of training reference images using the 3D feature prediction model;
reconstructing the training target image of the object based on the training 3D feature representation and the training target feature representation using the text-to-image generative model to obtain a reconstructed training target image; and
adjusting one or more parameters of the 3D feature prediction model by optimizing a loss function based on the training target image and the reconstructed training target image to obtain a trained 3D feature prediction model, thereby customizing the text-to-image generative model.

10. The system of claim 9, wherein the processing device is to perform further operations comprising:
receiving an input prompt and a target camera viewpoint;
accessing multiple feature representations associated with the multiple training images;
predicting a 3D feature representation of the object in the target camera viewpoint based on the multiple feature representations using the trained 3D feature prediction model; and
generating an image of the object in the target camera viewpoint based on the input prompt and the 3D feature representation of the object in the target camera viewpoint.

11. The system of claim 10, wherein the processing device is to perform further operations comprising:
rendering the 3D feature representation in the target camera viewpoint using a neural rendering algorithm to obtain a rendered 3D feature representation;
concatenating the rendered 3D feature representation with Gaussian noise to obtain a noised 3D feature representation rendering of the object in the target camera viewpoint; and
generating the image of the object in the target camera viewpoint based on the input prompt and the noised 3D feature representation rendering of the object in the target camera viewpoint.

12. The system of claim 9, wherein the processing device is to perform further operations comprising:
creating a noised training target image by adding noise data to the training target image; and
extracting the training target feature representation from the noised training target image using the transformer model of the one or more transformer models.

13. The system of claim 9, wherein the processing device is to perform further operations comprising:
extracting a set of training two-dimensional (2D) feature representations from the set of training reference images using a set of transformer models of the one or more transformer models; and
predicting the training 3D feature representation in the training target camera viewpoint based on the set of training 2D feature representations using the 3D feature prediction model.

14. The system of claim 9, wherein the processing device is to perform further operations comprising:
generating a training target prompt based on the training target image using a generative pre-trained transformer (GPT) model; and
providing the training target prompt to the one or more transformer models as a condition.

15. The system of claim 9, wherein the processing device is to perform further operations comprising:
rendering the training 3D feature representation using a neural rendering algorithm to obtain a rendered training 3D feature representation; and
concatenating the rendered training 3D feature representation with the training target feature representation to obtain a combined feature representation.
reconstructing the training target image by decoding the combined feature representation.

16. A non-transitory computer-readable medium, storing executable instructions, which when executed by a processing device, cause the processing device to perform operations comprising:
accessing multiple training images of an object for customizing a text-to-image generative model, the text-to-image generative model comprising one or more transformer models and a three-dimensional (3D) feature prediction model;
extracting a training target feature representation based on a training target image of the multiple training images using a transformer model of the one or more transformer models;
predicting a training 3D feature representation in a training target camera viewpoint using the 3D feature prediction model;
reconstructing the training target image of the object based on the training 3D feature representation and the training target feature representation using the text-to-image generative model to obtain a reconstructed training target image; and
a step for adjusting one or more parameters of the 3D feature prediction model based on the training target image and the reconstructed training target image to obtain a trained 3D feature prediction model, thereby customizing the text-to-image generative model.

17. The non-transitory computer-readable medium of claim 16, wherein the operations further comprise:
receiving an input prompt and a target camera viewpoint;
accessing multiple feature representations associated with the multiple training images;
predicting a 3D feature representation of the object in the target camera viewpoint based on the multiple feature representations using the trained 3D feature prediction model;
rendering the 3D feature representation in the target camera viewpoint using a neural rendering algorithm to obtain a rendered 3D feature representation;
concatenating the rendered 3D feature representation with Gaussian noise to obtain a noised 3D feature representation rendering of the object in the target camera viewpoint; and
generating an image of the object in the target camera viewpoint based on the input prompt and the noised 3D feature representation rendering of the object in the target camera viewpoint.

18. The non-transitory computer-readable medium of claim 16, wherein the operations further comprise:
creating a noised training target image by adding noise data to the training target image; and
extracting the training target feature representation from the noised training target image using the transformer model of the one or more transformer models.

19. The non-transitory computer-readable medium of claim 16, wherein the operations further comprise:
extracting a set of training two-dimensional (2D) feature representations from a set of training reference images of the multiple training images using a set of transformer models of the one or more transformer models; and
predicting the training 3D feature representation in the training target camera viewpoint based on the set of training 2D feature representations using the 3D feature prediction model;
rendering the training 3D feature representation using a neural rendering algorithm to obtain a rendered training 3D feature representation;
concatenating the rendered training 3D feature representation with the training target feature representation to obtain a combined feature representation; and
reconstructing the training target image by decoding the combined feature representation.

20. The non-transitory computer-readable medium of claim 16, wherein the operations further comprise:
generating a training target prompt based on the training target image using a generative pre-trained transformer (GPT) model; and
providing the training target prompt to the one or more transformer models as a condition.
